(19) United States
(12) Patent Application Publication
(10) Pub. No.: US 2026/0076352 A1
(43) Pub. Date: Mar. 19, 2026

(54) LURE

(71) Applicant: Shimano Inc., Osaka (JP)

(72) Inventor: Kimio KOKUGA, Osaka (JP)

(21) Appl. No.: 19/282,840

(22) Filed: Jul. 28, 2025

(30) Foreign Application Priority Data
Sep. 13, 2024 (JP) 2024-158742

(51) Int. Cl. A01K 85/16

(52) U.S. Cl. CPC A01K 85/16

(57) ABSTRACT

A lure includes a plate member and a body. The plate member has a line eye to which a line can be connected. The plate member is attached to the body. The body has a restricting portion. The restricting portion restricts the movement of the plate member relative to the body.

### CROSS-REFERENCE TO RELATED APPLICATIONS

This application claims priority to Japanese Patent Application No. 2024-158742, filed on September 13, 2024.The entire disclosure of Japanese Patent Application No. 2024-158742 is hereby incorporated by reference.

### BACKGROUND

### Technical Field

The present disclosure relates to a lure.

### Background Information

International publication no. 2018/081852 discloses a lure that uses a line eye in a plate-like member.

### SUMMARY

In the device described above for International publication no. 2018/081852, it has been determined that the line eye moves relative to the body so that the movement of the lure in water can be different from the movement desired by a user.

One object of the present disclosure is to provide a lure whose movement in water is improved.

The lure of a first aspect of the present disclosure comprises a plate member and a body. The plate member has a line eye to which a line can be connected. The plate member is attached to the body. The body has a restricting portion. The restricting portion restricts the movement of the plate member relative to the body.

According to the lure of the first aspect, the restricting portion can prevent the movement of the plate member relative to the body. As a result, the lure can stabilize the movement of the lure in water and improve the movement of the lure. By providing a line eye on the plate member, the lure can prevent distortion generated in the line eye. Therefore, the movement of the lure in water is stable. Accordingly, the movement of the lure in water can be improved.

In a lure of a second aspect according to the first aspect, the restricting portion has a first restricting part and a second restricting part. The first restricting part sandwiches the plate member forward of the line eye. The second restricting part sandwiches the plate member rearward of the line eye.

According to the lure of the second aspect, the plate member is sandwiched by the restricting portion, thereby making it possible to increase the rigidity of the plate member with respect to an external force, such as the tensile force of the line. As a result, the lure can suppress deformation of the line eye and positional displacement with respect to the body against external force such as the tensile force of the line. Therefore, the movement of the lure in water is stable. Accordingly, the movement of the lure in water can be improved.

In a lure of a third aspect according to the first or the second aspect, the plate member includes a first hole and second holes. The first hole is formed forward of the line eye. The second holes are formed rearward of the line eye. The restricting portion has a first pin and second pins. The first pin is inserted into the first hole. The second pins are inserted into the second holes.

According to the lure of the third aspect, the movement of the plate member relative to the body is restricted by the first and second pins. As a result, the lure can prevent the movement of the plate member relative to the body. Therefore, the movement of the lure in water is stable. Accordingly, the movement of the lure in water can be improved.

In a lure of a fourth aspect according to the third aspect, a slit is formed in the plate member. The slit is connected to the line eye. The second holes are formed above the slit as well as below the slit.

According to the lure of the fourth aspect, it is possible to prevent the plate member above the slit as well as the plate member below the slit from moving relative to the body. Therefore, the movement of the lure in water is stable. Accordingly, the movement of the lure in water can be improved.

In a lure of a fifth aspect according to the third aspect, a slit that is connected to the line eye is formed in the plate member. The second hole is formed so as to include a portion of the slit.

According to the lure of the fifth aspect, it is possible to prevent the plate member above the slit as well as the plate member below the slit from moving relative to the body with one of the second pins inserted into the second holes. As a result, the lure can prevent the plate member above the slit as well as the plate member below the slit from moving relative to the body, while simplifying the configuration of the body.

According to the lure of the present disclosure, it is possible to improve the movement of the lure in water.

### BRIEF DESCRIPTION OF THE DRAWINGS

FIG. 1 is a side view of a lure according to a first embodiment.

FIG. 2 is a plan view of the lure according to the first embodiment.

FIG. 3 is a side view of a first body part according to the first embodiment as viewed from a second body part side.

FIG. 4 is a side view of the second body part according to the first embodiment as viewed from the first body part side.

FIG. 5 is a cross-sectional view taken along line V-V in FIG. 2.

FIG. 6 is a cross-sectional view taken along line VI-VI in FIG. 2.

FIG. 7 is a cross-sectional view taken along line VII-VII in FIG. 2.

FIG. 8 is an enlarged view of a front side of the lure in FIG. 7.

FIG. 9 is a diagram explaining a lure according to a modified example.

FIG. 10 is a diagram explaining a lure according to a modified example.

FIG. 11 is a plan view showing the front side of a lure according to the second embodiment.

FIG. 12 is an enlarged side view of the front side of the lure according to the second embodiment, with the second body part omitted.

FIG. 13 is a side view of the front side of the first body part according to the second embodiment as viewed from a second body part side.

FIG. 14 is a side view of the front side of the second body part according to the second embodiment as viewed from a first body part side.

FIG. 15 is a perspective view of an elastic member according to the second embodiment.

FIG. 16 is a diagram explaining a lure according to a modified example.

### DETAILED DESCRIPTION

### Embodiment 1

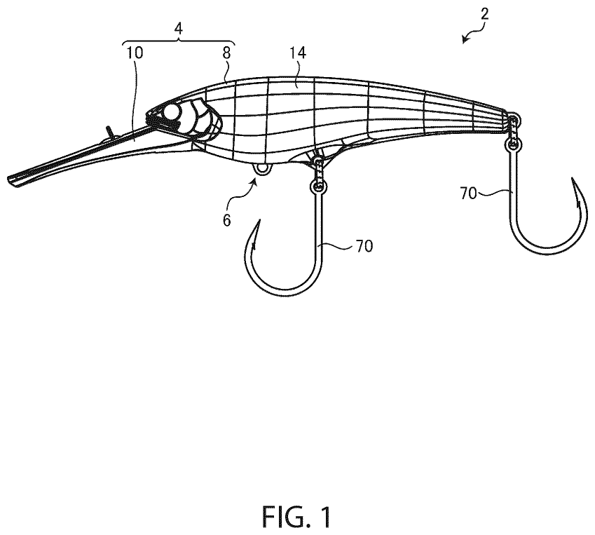

A lure 2 according to the first embodiment will be described with reference to FIGS. 1-7. The lure 2 is, for example, a lure for capturing large fish (fish eaters) that prey on small fish. Examples of large fish include largemouth bass, yellowtail, juvenile yellowtail, and sea bass. The lure 2 has a shape resembling a small fish.

In this Specification, terms indicating the directions “front,” “rear,” “forward (front side),” “rearward (rear side),” “left,” “right,” “leftward,” “rightward,” “up,” “down,” “upward,” “downward,” as well as any other similar direction, are defined as follows.

“Front” and “forward (front side)” indicate the direction of travel in which the lure 2 travels while being pulled by a line (fishing line) to which the lure 2 is connected. “Rear” and “rearward (rear side)” are directions opposite to the direction of travel. “forward-rearward direction”corresponds to the longitudinal direction of the lure 2.

“Up” and “upward” indicate the direction toward the surface of the water when the lure 2 is moving forward in the water. “Down” and “downward” indicate the direction toward the bottom of the water when the lure 2 is moving forward in the water. “Left,” “leftward,” “right,” and “rightward” are defined based on “up” and “down”.

As shown in FIG. 1, the lure 2 comprises a body 4 and a plate member 6. The body 4 is formed so as to extend in the forward-rearward direction. The body 4 is made of resin. The body 4 has a body portion 8 and a lip 10. The body portion 8 is formed to match the shape of a small fish. The lip 10 is formed so as to protrude forward from the front end of the body portion 8.

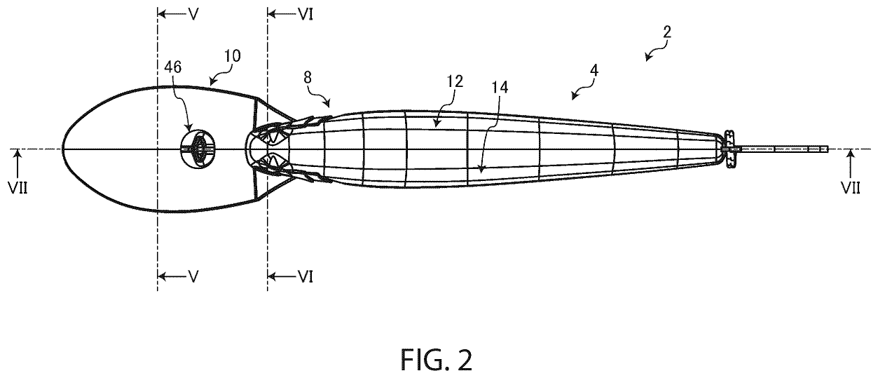

As shown in FIG. 2, the body 4 includes a first body part 12 and a second body part 14. The body 4 is divided into the first body part 12 and the second body part 14 in the left-right direction. The body 4 is formed by joining the first body part 12 and the second body part 14. In other words, the body 4 can be split in to two halves in the left-right direction. The first half being the first body part 12 and the second half being the second body part 14.

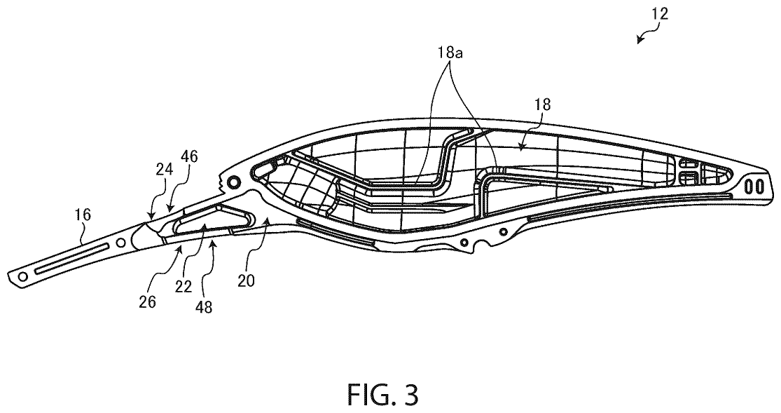

As shown in FIG. 3, the first body part 12 has a protrusion 16. The protrusion 16 is formed on the first body part 12 on the front side. When the body 4 is formed, the protrusion 16 constitutes the lip 10 (refer to FIG. 2). A first recess 18, a second recess 20, and a third recess 22 are formed in the first body part 12. A first communication hole 24 and a second communication hole 26 are formed in the first body part 12.

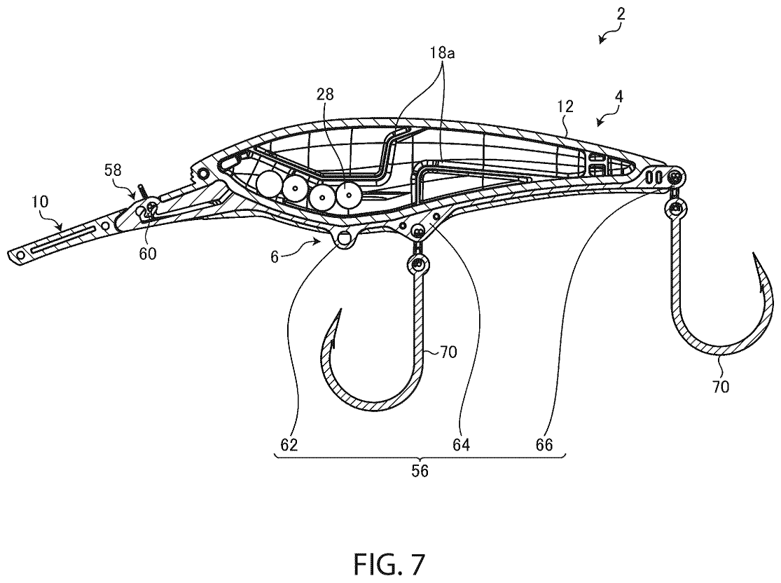

The first recess 18 is formed so as to be recessed rightward relative to the second body part 14 (refer to FIG. 2) side. The first recess 18 is formed extending in the forward-rearward direction. Guide walls 18a are formed in the first recess 18. The guide walls 18a are formed so as to guide the movement of a weight 28 (refer to FIG. 7). The guide walls 18a are formed such that the weight 28 moves rearward when the lure 2 is cast. The guide walls 18a are formed such that the weight 28 moves forward when the lure 2 hits water. The lure 2 can be configured such that the body 4 does not accommodate the weight 28.

The second recess 20 is formed so as to be recessed rightward relative to the second body part 14 side. The second recess 20 is formed so as to pass below the first recess 18 and extend in the forward-rearward direction. Specifically, the second recess 20 is formed extending from the protrusion 16 to the rear end.

The third recess 22 is formed so as to be further recessed rightward relative to the second recess 20 on the front side. At least a portion of the third recess 22 is formed in the protrusion 16.

The first communication hole 24 is formed in the protrusion 16. The first communication hole 24 is formed so as to be opened upward. The lower end of the first communication hole 24 is connected to the third recess 22. The first communication hole 24 is formed so as to widen in the upward direction.

The second communication hole 26 is formed in the protrusion 16. The second communication hole 26 is formed so as to be opened in the downward direction. The upper end of the second communication hole 26 is connected to the third recess 22.

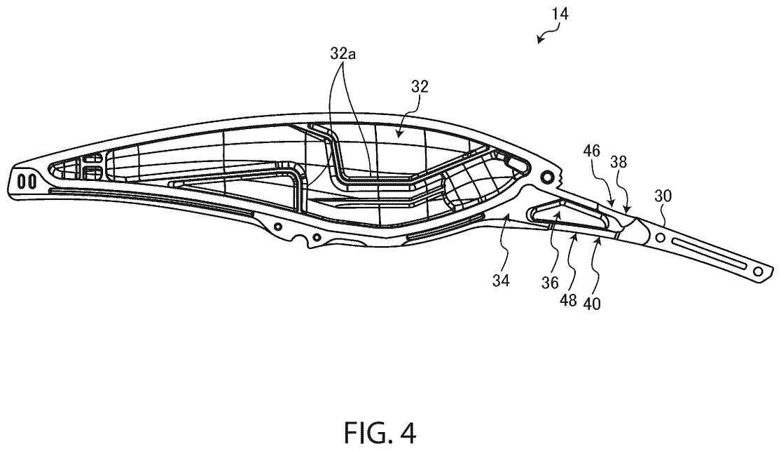

As shown in FIG. 4, the second body part 14 has a protrusion 30. The protrusion 30 is formed on the second body part 14 on the front side. When the body 4 is formed, the protrusion 30 constitutes the lip 10 (refer to FIG. 2). A first recess 32, a second recess 34, and a third recess 36 are formed in the second body part 14. A first communication hole 38 and a second communication hole 40 are formed in the second body part 14.

The first recess 32 is formed so as to be recessed leftward from the first body part 12 (refer to FIG. 2) side. The first recess 32 is formed extending in the forward-rearward direction. Guide walls 32a are formed in the first recess 32. The guide walls 32a are formed so as to guide the movement of the weight 28 (refer to FIG. 7), in the same manner as the guide walls 18a formed in the first recess 18 of the first body part 12.

The second recess 34 is formed so as to be recessed leftward relative to the first body part 12 side. The second recess 34 is formed so as to pass below the first recess 32 and extend in the forward-rearward direction. Specifically, the second recess 34 is formed extending from the protrusion 30 to the rear end.

The third recess 36 is formed so as to be further recessed leftward from the second recess 34 on the front side. At least a portion of the third recess 36 is formed in the protrusion 30.

The first communication hole 38 is formed in the protrusion 30. The first communication hole 38 is formed so as to be opened in the upward direction. The lower end of the first communication hole 38 is connected to the third recess 36. The first communication hole 38 is formed so as to widen in the upward direction.

The second communication hole 40 is formed in the protrusion 30. The second communication hole 40 is formed so as to be opened in the downward direction. The upper end of the second communication hole 40 is connected to the third recess 36.

The first body part 12 and the second body part 14 are joined by ultrasonic welding, for example. The first body part 12 and the second body part 14 can be bonded to each other. When the first body part 12 and the second body part 14 are joined, the first communication holes 24, 38 form a first communication hole 46. Similarly, the second communication holes 26, 40 form a second communication hole 48.

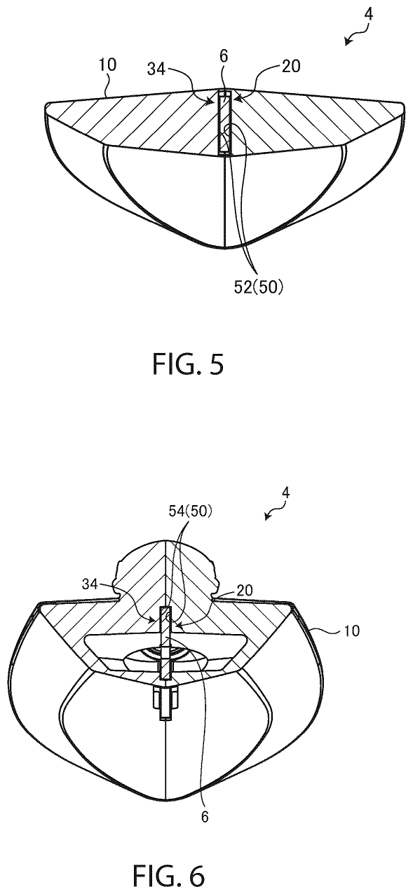

As shown in FIGS. 5 and 6, the body 4 has a restricting portion 50. The restricting portion 50 restricts the movement of the plate member 6 relative to the body 4. The restricting portion 50 has a first restricting part 52 and a second restricting part 54. As shown in FIG. 5, the first restricting part 52 sandwiches the plate member 6 on the front side of a plurality of line eyes 58, described further below. The first restricting part 52 sandwiches the plate member 6 from the left and right directions. Specifically, the first restricting part 52 is the left and right side walls in the second recesses 20, 34.

As shown in FIG. 6, the second restricting part 54 sandwiches the plate member 6 on the rear side the plurality of line eyes 58, described further below. The second restricting part 54 sandwiches the plate member 6 from the left and right directions. Specifically, the second restricting part 54 is the left and right side walls in the second recesses 20, 34.

As shown in FIG. 7, the plate member 6 is a plate-like member. The plate member 6 is made of metal. The plate member 6 is attached to the body 4. Specifically, the plate member 6 is disposed in the second recess 20 (refer to FIG. 3) of the first body part 12 and the second recess 34 (refer to FIG. 4) of the second body part 14. The plate member 6 is provided at the center of the body 4 in the left-right direction.

The plate member 6 is provided with a plurality of hook eyes 56. The plate member 6 includes a plurality of line eyes 58. The plate member 6 includes a partition wall 60.

The plurality of hook eyes 56 include a first hook eye 62, a second hook eye 64, and a third hook eye 66. A hook 70 can be connected to the plurality of hook eyes 56. FIG. 7 shows an example in which two hooks 70 are connected to the second hook eye 64 and the third hook eye 66.

The first hook eye 62 and the second hook eye 64 are protrude in the downward direction. The third hook eye 66 protrudes in the rearward direction. The number of the hook eyes 56 is not limited to three. The number of the hook eyes 56 can be two. The number of the hook eyes 56 can be four or more. The plate member 6 can be provided with one hook eye 56.

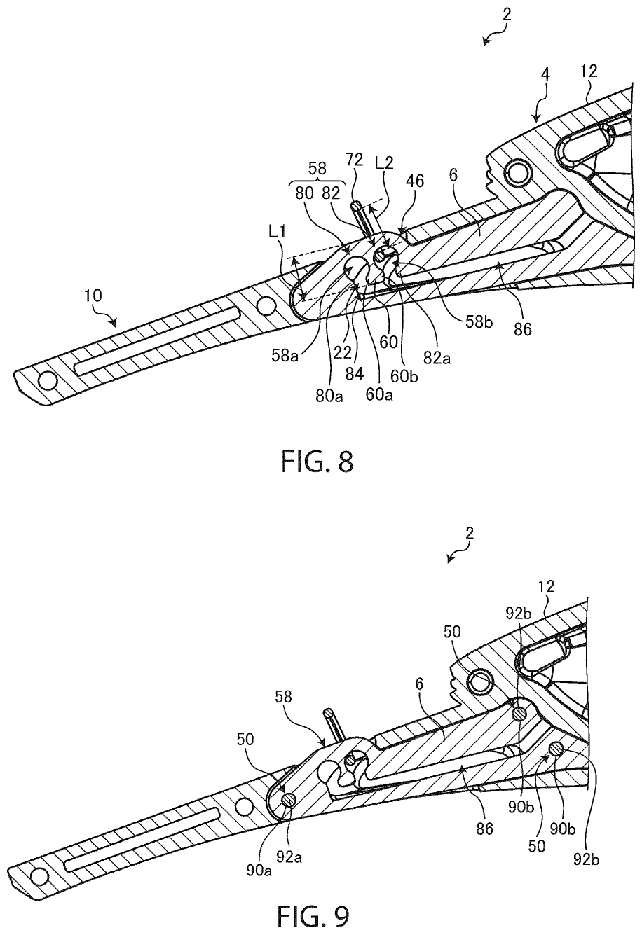

The plurality of line eyes 58 are provided forward of the plurality of hook eyes 56. The plurality of line eyes 58 are formed in the plate member 6 on the front side. As shown in FIG. 8, the plurality of line eyes 58 are provided on the lip 10. Specifically, the plurality of line eyes 58 are disposed in the third recesses 22, 36 (refer to FIG. 4) and the first communication hole 46. The plurality of line eyes 58 are provided such that the upper portions of the plurality of line eyes 58 protrude upward from the first communication hole 46.

The plurality of line eyes 58 are arranged side by side in the forward-rearward direction. For example, in one embodiment, two line eyes 58 can be provided. In this embodiment, the plurality of line eyes 58 include a first line eye 80 and a second line eye 82. The number of the line eyes 58 is not limited to two. Three or more of the line eyes 58 can be provided. A line can be connected to the plurality of line eyes 58. Specifically, a line can be connected to the line eyes 58 via a ring member 72. The plurality of line eyes 58 are formed by a plurality of holes 58a, 58b formed in the plate member 6. That is, the plurality of holes 58a, 58b into which the ring member 72 can be inserted are formed in the plate member 6. The plurality of line eyes 58 are connected to each other via a communication hole 84.

The first line eye 80 is formed forward of the second line eye 82. The first line eye 80 has a protrusion 80a. The protrusion 80a protrudes toward the partition wall 60. Specifically, the protrusion 80a protrudes rearward. The protrusion 80a is formed at the lower end of the first line eye 80.

The second line eye 82 has a protrusion 82a. The protrusion 82a protrudes toward the partition wall 60. Specifically, the protrusion 82a protrudes in the forward direction. The protrusion 82a is formed at the lower end of the second line eye 82.

The partition wall 60 is formed between the plurality of line eyes 58. The partition wall 6 is configured to separate the plurality of line eyes 58. Specifically, the partition wall 60 is configured to separate the hole 58a forming the first line eye 80 and the hole 58b forming the second line eye 82. The partition wall 60 is formed as a result of the plurality of holes 58a, 58b being formed in the plate member 6. A length L1 of the partition wall 60 in the upward-downward direction is shorter than an inner diameter L2 of the ring member 72. The length L1 of the partition wall 60 is the length from the upper end surfaces of the plurality of line eyes 58 to the lower end of the partition wall 60. The partition wall 60 has a first protrusion 60a and a second protrusion 60b. The first protrusion 60a and the second protrusion 60b protrude in the forward-rearward direction from the lower end of the partition wall 60.

The first protrusion 60a protrudes in the forward direction from the lower end of the partition wall 60. The first protrusion 60a is formed so as to face the protrusion 80a of the first line eye 80. The second protrusion 60b protrudes in the rearward direction from the lower end of the partition wall 60. The second protrusion 60b is formed so as to face the protrusion 82a of the second line eye 82.

The plate member 6 can include just one of the protrusion 80a of the first line eye 80 and the first protrusion 60a of the partition wall 60. The plate member 6 can include just one of the protrusion 82a of the second line eye 82 and the second protrusion 60b of the partition wall 60.

The communication hole 84 is formed in the plate member 6. A slit 86 is formed in the plate member 6. The communication hole 84 is formed extending in the forward-rearward direction. The communication hole 84 is formed so as to pass below the partition wall 60. The communication hole 84 is connected to the plurality of line eyes 58. The communication hole 84 is connected to the lower ends of the plurality of line eyes 58. Specifically, the communication hole 84 is connected to the lower ends of the plurality of holes 58a, 58b forming the plurality of line eyes 58.

The slit 86 is connected to the communication hole 84. Specifically, the slit 86 is connected to the rear end of the communication hole 84. That is, the slit 86 is connected to the plurality of line eyes 58 via the communication hole 84. The slit 86 is formed extending in the rearward direction from the communication hole 84. The slit 86 is formed so as to be opened at the rear end.

When manufacturing the lure 2, the ring member 72 is inserted into the slit 86 from the opening formed at the rear end of the slit 86. The ring member 72 is inserted into the communication hole 84 from the slit 86. The ring member 72 is inserted from the communication hole 84 into either one of the holes 58a and 58b forming the plurality of line eyes 58. The ring member 72 is thereby attached to any one of the plurality of line eyes 58.

Next, the plate member 6 to which the ring member 72 is attached is disposed in the second recess 20 of the first body part 12 or the second recess 34 of the second body part 14. The weight 28 is disposed in the second recess 20 of the first body part 12 or the second recess 34 of the second body part 14.

Next, the first body part 12 and the second body part 14 are joined together to produce the lure 2. When the first body part 12 and the second body part 14 are joined together, the slit 86 is enclosed in the body 4. The ring member 72 can be attached to any one of the plurality of line eyes 58 after the first body part 12 and the second body part 14 are joined together.

When changing the line eye 58 to which the ring member 72 is attached, the user inserts the ring member 72 into the communication hole 84 from the original line eye 58. Next, the user moves the ring member 72 along the communication hole 84 and inserts the ring member 72 into the line eye 58 from the communication hole 84. In this manner, the user changes the line eye 58 to which the ring member 72 is attached via the communication hole 84.

The plate member 6 is sandwiched from the left and right directions by the restricting portion 50. Since the plate member 6 is sandwiched by the restricting portion 50, the rigidity of the line eye 58 increases against external force such as the tensile force of the line. As a result, deformation, etc., of the line eye 58 is suppressed even if external force is applied to the line eye 58.

In the lure 2 according to a modified example, a first hole 90a and second holes 90b are formed in the plate member 6, as shown in FIG. 9. The first hole 90a is formed forward of the plurality of line eyes 58. The second holes 90b are formed rearward of the plurality of line eyes 58. A plurality of the second holes 90b are formed. For example, two of the second holes 90b are formed. The second holes 90b are formed above the slit 86 as well as below the slit 86. The number of the second holes 90b can be one.

The restricting portion 50 includes a first pin 92a and second pins 92b. The first pin 92a is formed forward of the plurality of line eyes 58. The first pin 92a is configured to protrude from a side wall of the second recess 20 (refer to FIG. 3) of the first body part 12 toward the second body part 14 (refer to FIG. 2) side. The first pin 92a can be configured to protrude from a side wall of the second recess 34 (refer to FIG. 4) of the second body part 14 toward the first body part 12 side. The first pin 92a is inserted into the first hole 90a. The first pin 92a is formed so as to fit into the first hole 90a.

The second pins 92b are formed rearward of the plurality of line eyes 58. The second pins 92b are provided rearward of the first pin 92a. The second pins 92b are formed to protrude from a side wall of the second recess 20 (refer to FIG. 3) of the first body part 12 toward the second body part 14 (refer to FIG. 2) side. The second pins 92b can be formed to protrude from a side wall of the second recess 34 (refer to FIG. 4) of the second body part 14 toward the first body part 12 side. A plurality of the second pins 92b are formed. For example, two of the second pins 92b are formed. The second pins 92b are inserted into the second holes 90b. The second pins 92b are formed so as to fit into the second holes 90b.

The restricting portion 50 restricts the movement of the plate member 6 relative to the body 4 with the first pin 92a and the second pins 92b. The restricting portion 50 can restrict the movement of the plate member 6 relative to the body 4 with only the first pin 92a, or with only the second pins 92b.

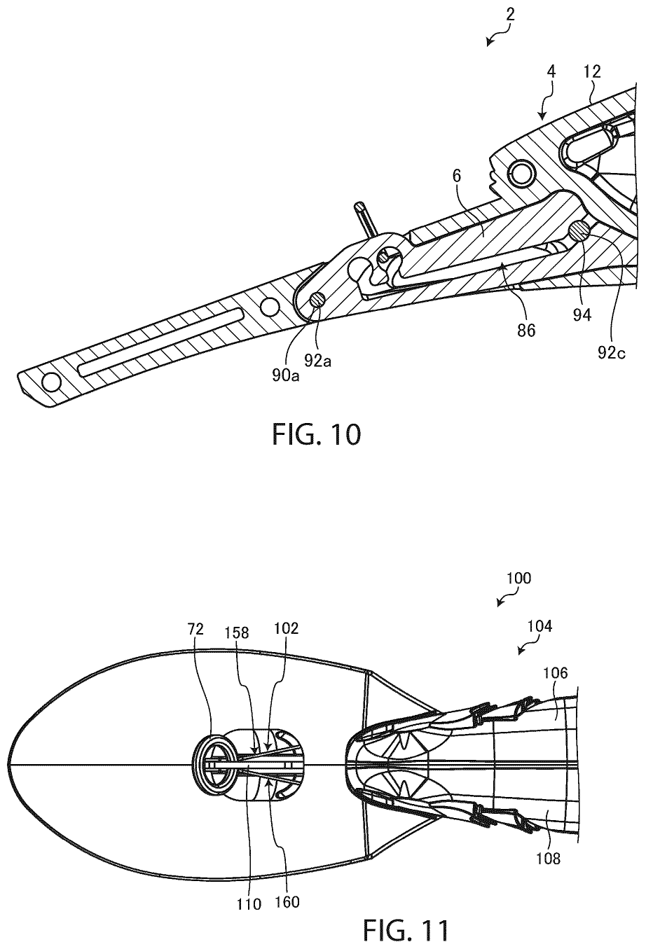

As shown in FIG. 10, a second hole 94 formed in the plate member 6 can be formed so as to include a portion of the slit 86. The second hole 94 is formed such that the slit 86 penetrates therethrough. The movement of the plate member 6 relative to the body 4 is restricted by one of the second pins 92c that is inserted into the second hole 94.

### Embodiment 2

A lure 100 according to a second embodiment will be described with reference to FIGS. 11-15. Descriptions of configurations that are the same as those of the first embodiment will be omitted. As shown in FIG. 11, the lure 100 comprises an elastic member 102. A body 104 of the lure 100 is formed by joining the first body part 106 and the second body part 108, in the same manner as in the first embodiment.

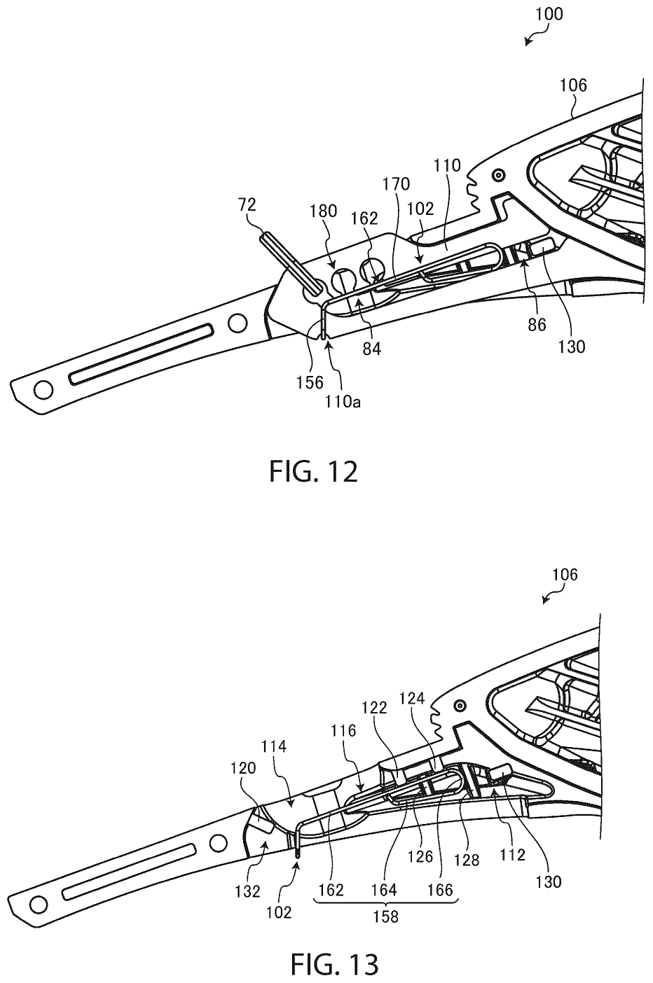

A groove 110a is formed in a plate member 110 of the lure 100 according to the second embodiment, as shown in FIG. 12. The groove 110a is formed in the plate member 110 on the front side. The groove 110a is formed at the lower end of the plate member 110. The groove 110a is formed so as to be recessed upward.

A third recess 112 on the front side of the first body part 106 is formed such that the length thereof in the upward-downward direction decreases toward the front, as shown in FIG. 13. In FIG. 13, a portion of the elastic member 102 is depicted. A first communication hole 114 of the first body part 106 is connected to the third recess 112 via a fifth communication hole 116. The first body part 106 includes a first protrusion 120, a second protrusion 122, a third protrusion 124, a fourth protrusion 126, a fifth protrusion 128, and a sixth protrusion 130.

The first protrusion 120 is formed forward of the first communication hole 114. The first protrusion 120 protrudes from a side wall of a second recess 132 toward the second body part 108 (refer to FIG. 11) side.

The second protrusion 122 is formed rearward of the first communication hole 114. The second protrusion 122 protrudes from a side wall of the second recess 132 toward the second body part 108 (refer to FIG. 11) side. The second protrusion 122 protrudes into the third recess 112.

The third protrusion 124 is formed rearward of the second protrusion 122. The third protrusion 124 protrudes from a side wall of the second recess 132 toward the second body part 108 (refer to FIG. 11) side. The third protrusion 124 protrudes into the third recess 112. The first body part 106 can include one of the second protrusion 122 and the third protrusion 124.

The fourth protrusion 126 protrudes from a side wall of the third recess 112 toward the second body part 108 (refer to FIG. 11) side. The fifth protrusion 128 is formed rearward of the fourth protrusion 126. The fifth protrusion 128 protrudes from a side wall of the third recess 112 toward the second body part 108 (refer to FIG. 11) side.

The sixth protrusion 130 is formed rearward of the fifth protrusion 128. The sixth protrusion 130 protrudes from a side wall of the second recess 132 toward the second body part 108 (refer to FIG. 11) side. As shown in FIG. 12, the sixth protrusion 130 is inserted into the slit 86 of the plate member 110.

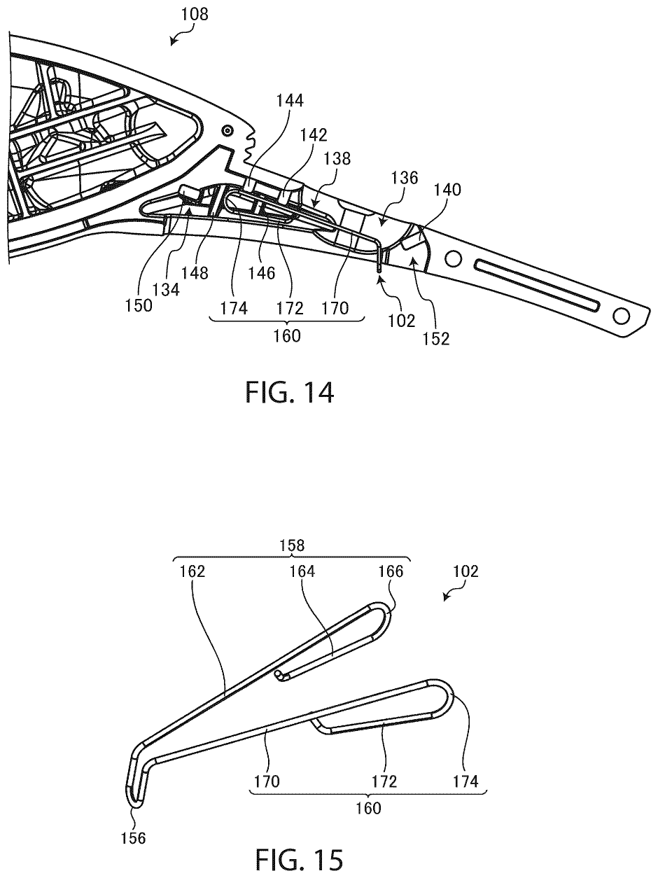

A third recess 134 on the front side of the first body part 108 is formed such that the length thereof in the upward-downward direction decreases toward the front, as shown in FIG. 14. In FIG. 14, a portion of the elastic member 102 is depicted. A first communication hole 136 of the second body part 108 is connected to the third recess 134 via a fifth communication hole 138. The second body part 108 includes a first protrusion 140, a second protrusion 142, a third protrusion 144, a fourth protrusion 146, a fifth protrusion 148, and a sixth protrusion 150.

The first protrusion 140 is formed forward of the first communication hole 136. The first protrusion 140 protrudes from a side wall of a second recess 152 toward the first body part 106 (refer to FIG. 11) side. The first protrusion 140 is formed so as to face the first protrusion 120 (refer to FIG. 13) of the first body part 106 with the plate member 110 (refer to FIG. 12) interposed therebetween.

The second protrusion 142 is formed rearward of the first communication hole 136. The second protrusion 142 protrudes from a side wall of a second recess 152 toward the first body part 106 (refer to FIG. 11) side. The second protrusion 142 is formed so as to face the second protrusion 122 (refer to FIG. 13) of the first body part 106 with the plate member 110 (refer to FIG. 12) interposed therebetween. The second protrusion 142 protrudes into the third recess 134.

The third protrusion 144 is formed rearward of the second protrusion 142. The third protrusion 144 protrudes from a side wall of the second recess 152 toward the first body part 106 (refer to FIG. 11) side. The third protrusion 144 is formed so as to face the third protrusion 124 (refer to FIG. 13) of the first body part 106 with the plate member 110 (refer to FIG. 12) interposed therebetween. The third protrusion 144 protrudes into the third recess 134. The second body part 108 can include one of the second protrusion 142 and the third protrusion 144.

The fourth protrusion 146 protrudes from a side wall of a third recess 134 toward the first body part 106 (refer to FIG. 11) side. The fifth protrusion 148 is formed rearward of the fourth protrusion 146. The fifth protrusion 148 protrudes from a side wall of the third recess 134 toward the first body part 106 (refer to FIG. 11) side.

The sixth protrusion 150 is formed rearward of the fifth protrusion 148. The sixth protrusion 150 protrudes from a side wall of a second recess 152 toward the first body part 106 (refer to FIG. 11) side. The sixth protrusion 150 is inserted into the slit 86 (refer to FIG. 12) of the plate member 110. The lure 100 can include one of the sixth protrusion 130 (refer to FIG. 13) of the first body part 106 and the sixth protrusion 150 of the second body part 108.

As shown in FIG. 15, the elastic member 102 includes a connection portion 156, a first arm portion 158, and a second arm portion 160. The connection portion 156 is formed so as to have an essentially U-shape when viewed from the forward-rearward direction.

The first arm portion 158 extends rearward from the upper end of the connection portion 156 on the right side. The first arm portion 158 is formed so as to be inclined in the rightward direction toward the rear. The second arm portion 160 extends in the rearward direction from the upper end of the connection portion 156 on the left side.

The second arm portion 160 is formed so as to be inclined in the leftward direction toward the rear. That is, the first arm portion 158 and the second arm portion 160 are formed so as to widen in the left and right directions toward the rear.

The first arm portion 158 includes a first straight portion 162, a second straight portion 164, and a folded-back portion 166. The first straight portion 162 is formed extending rearward from the upper end of the connection portion 156. The second straight portion 164 is formed below the first straight portion 162. The first straight portion 162 and the second straight portion 164 are formed such that the distance between the first straight portion 162 and the second straight portion 164 in the upward-downward direction increases toward the rear. The folded-back portion 166 is formed curved so as to fold back from the rear end of the first straight portion 162 to the front side. The folded-back portion 166 connects the rear end of the first straight portion 162 and the rear end of the second straight portion 164.

The second arm portion 160 includes a first straight portion 170, a second straight portion 172, and a folded-back portion 174. The first straight portion 170 is formed extending rearward from the upper end of the connection portion 156.

The second straight portion 172 is formed below the first straight portion 170. The first straight portion 170 and the second straight portion 172 are provided such that the distance between the first straight portion 170 and the second straight portion 172 in the upward-downward direction increases toward the rear. The folded-back portion 174 is formed curved so as to fold back from the rear end of the first straight portion 170 to the front side. The folded-back portion 174 connects the rear end of the first straight portion 170 and the rear end of the second straight portion 172.

As shown in FIG. 12, the elastic member 102 is provided such that the connection portion 156 straddles the lower end of the plate member 110. Specifically, the connection portion 156 is inserted into the groove 110a of the plate member 110. The connection portion 156 can be engaged with the groove 110a of the plate member 110. The first straight portions 162, 170 of the elastic member 102 are provided near the upper end of the communication hole 84, for example. As shown in FIG. 11, the first arm portion 158 is provided to the right of the plate member 110. The second arm portion 160 is provided to the left of the plate member 110. The elastic member 102 is supported by the body 104.

As shown in FIG. 13, a portion of the first arm portion 158 of the elastic member 102 is accommodated in the third recess 112 of the first body part 106. Specifically, a portion of the first straight portion 162, the second straight portion 164, and the folded-back portion 166 of the first arm portion 158 are accommodated in the third recess 112. As shown in FIG. 14, a portion of the second arm portion 160 of the elastic member 102 is accommodated in the third recess 134 of the second body part 108. Specifically, a portion of the first straight portion 170, the second straight portion 172, and the folded-back portion 174 of the second arm portion 160 are accommodated in the third recess 134.

As shown in FIG. 13, the first straight portion 162 of the first arm portion 158 accommodated in the third recess 112 abuts against the lower end surface of the second protrusion 122 of the first body part 106 and the lower end surface of the third protrusion 124 of the first body part 106. The second straight portion 164 abuts against the bottom surface of the third recess 112 of the first body part 106. As shown in FIG. 14, the first straight portion 170 of the second arm portion 160 accommodated in the third recess 134 abuts against the lower end surface of the second protrusion 142 of the second body part 108 and the lower end surface of the third protrusion 144 of the second body part 108. The second straight portion 172 of the second arm portion 160 abuts against the bottom surface of the third recess 134 of the second body part 108. That is, the elastic member 102 is supported by the second protrusions 122, 142, the third protrusions 124, 144, and the third recesses 112, 134 in the upward-downward direction. The forward movement of the elastic member 102 is restricted by the second protrusions 122, 142 and the third protrusions 124, 144.

The first straight portion 162 and/or the second straight portion 164 (refer to FIG. 13) of the first arm portion 158 accommodated in the third recess 112 abuts against the left end surface of the fourth protrusion 126 (refer to FIG. 13) of the first body part 106. The first straight portion 170 and/or the second straight portion 172 (refer to FIG. 14) of the second arm portion 160 accommodated in the third recess 134 abuts against the right end surface of the fourth protrusion 146 (refer to FIG. 14) of the second body part 108. That is, the elastic member 102 is supported by the fourth protrusions 126, 146 in the left-right direction.

As shown in FIG. 13, the rear-end portion of the folded-back portion 166 of the first arm portion 158 abuts against the front end surface of the fifth protrusion 128 of the first body part 106. As shown in FIG. 14, the rear-end portion of the folded-back portion 174 of the second arm portion 160 abuts against the front end surface of the fifth protrusion 148 of the second body part 108. The rearward movement of the elastic member 102 is restricted by the fifth protrusions 128, 148.

As shown in FIG. 12, the elastic member 102 is configured to suppress the movement of the ring member 72 into the communication hole 84. The elastic member 102 suppresses the movement of the ring member 72 from the plurality of line eyes 180 to the communication hole 84. For example, when the ring member 72 abuts against the elastic member 102 during use of the lure 100, the movement of the ring member 72 to the communication hole 84 is suppressed by the elastic member 102. For example, when the elastic member 102 is pushed downward by the ring member 72 during use of the lure 100, a biasing force that pushes the ring member 72 upward is generated in the elastic member 102. Therefore, the movement of the ring member 72 into the communication hole 84 is suppressed by the elastic member 102. That is, the ring member 72 is suppressed from moving between the plurality of line eyes 180 during use of the lure 100.

When changing the line eye 180 to which the ring member 72 is attached, the user brings the ring member 72 in contact with the elastic member 102 and pushes the ring member 72 toward the communication hole 84 side against the biasing force of the elastic member 102. When the ring member 72 is pressed toward the communication hole 84 side, the elastic member 102 is elastically deformed. For example, the elastic member 102 elastically deforms such that the front side curves downward. The ring member 72 is thereby inserted into the communication hole 84. Next, the user moves the ring member 72 along the communication hole 84 and inserts the ring member 72 into the line eye 180 from the communication hole 84. In this manner, the user changes the line eye 180 to which the ring member 72 is attached via the communication hole 84. When the ring member 72 is inserted into the line eye 180, the elastic member 102 returns to the original state.

The body 104 sandwiches the plate member 110 from the left and right directions with the first protrusions 120, 140. The first protrusions 120, 140 sandwich the plate member 110 on the front side of the plurality of line eyes 180. That is, the first protrusions 120, 140 constitute the first restricting part 52.

The body 104 sandwiches the plate member 110 from the left and right directions with the second protrusions 122, 142 and the third protrusions 124, 144. The second protrusions 122, 142 and the third protrusions 124, 144 sandwich the plate member 110 on the rear side of the plurality of line eyes 180. That is, the second protrusions 122, 142 and the third protrusions 124, 144 constitute the second restricting part 54.

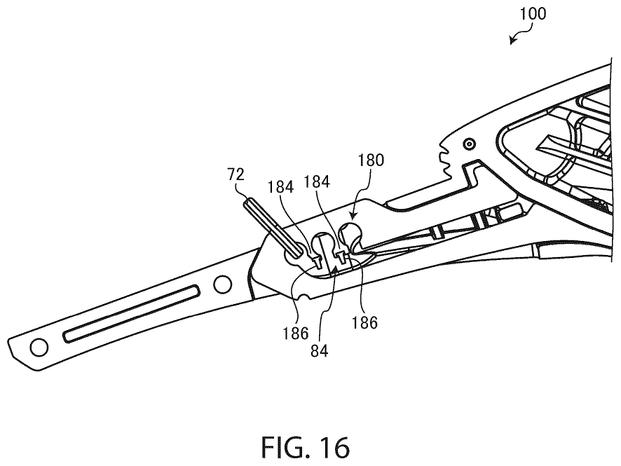

The lure 100 according to a modified example can include an elastic body 186 at the lower end of a partition wall 184, as shown in FIG. 16. The elastic body 186 is configured to protrude into the communication hole 84. The elastic body 186 is configured to protrude into the communication hole 84 from the lower end of the partition wall 184, for example. The elastic body 186 is, for example, rubber.

The elastic body 186 contacts the ring member 72 when the ring member 72 passes. When the ring member 72 is inserted into the communication hole 84 during use of the lure 100, the elastic body 186 prevents the ring member 72 from moving between the plurality of line eyes 180. When changing the line eye 180 to which the ring member 72 is attached, the user moves the ring member 72 against the elastic force of the elastic body 186 to change the line eye 180 to which the ring member 72 is attached.

As used in the present Specification, the phrase “at least one” means “one or more” of desired options. As an example, the phrase “at least one” as used in the present Specification means, if the number of options is two, “only one of the options” or “both of the two options.” As another example, the phrase “at least one” as used in the present Specification means, if the number of options is three or more, “only one of the options” or “any combination of two or more of the options.”

What is claimed is:

1. A lure, comprising:
a plate member having a line eye to which a line is configured to be connected; and
a body to which the plate member is attached,
the body including a restricting portion configured to restrict movement of the plate member relative to the body.

2. The lure according to claim 1, wherein
the restricting unit includes
a first restricting part configured to sandwich the plate member forward of the line eye, and
a second restricting part configured to sandwich the plate member rearward of the line eye.

3. The lure according to claim 1, wherein
the plate member has
a first hole formed forward of the line eye, and
second holes formed rearward of the line eye, and
the restricting unit includes
a first pin inserted into the first hole, and
second pins inserted into the second holes.

4. The lure according to claim 3, wherein
a slit is connected to the line eye and is formed in the plate member, and
the second holes are formed above the slit and below the slit.

5. The lure according to claim 3, wherein
a slit is connected to the line eye and is formed in the plate member, and
the second holes are formed so as to include a portion of the slit.
